(19) United States
(12) Patent Application Publication
(10) Pub. No.: US 2024/0414052 A1
(43) Pub. Date: Dec. 12, 2024

(54) METHOD AND SYSTEM OF TRANSFERRING DATA

(71) Applicant: BARCO NV, Kortrijk (BE)

(72) Inventors: Johannes Willem BRANDS, Kortrijk (BE); Roeland VAN LEMBERGEN, Kortrijk (BE); Filip LOUWET, Kortrijk (BE)

(73) Assignee: BARCO NV, Kortrijk (BE)

(21) Appl. No.: 18/698,948

(22) PCT Filed: Oct. 7, 2022
(86) PCT No.: PCT/EP2022/077982

§ 371 Date: Apr. 5, 2024

(30) Foreign Application Priority Data
Oct. 8, 2021 (SE) 2151237-1

(51) Int. Cl. H04L 41/082; H04L 67/00; H04W 8/30; H04W 92/02

(52) U.S. Cl. CPC H04L 41/082; H04L 67/34; H04W 8/30; H04W 92/02

(57) ABSTRACT

A method for transferring data between a server (2) and an equipment (1) which cannot establish a direct wireless communication with the server. The method comprises each of at least two user devices (3, 4, 5, 7) establishing a first wireless communication channel with the equipment and establishing a second communication channel for connecting to the server; establishing an indirect wireless communication between the equipment and the server via the at least two user devices; transferring data between the equipment and the server through the established indirect wireless communication. A first and a second part of the data is transferred via a first and a second user device of the at least two user devices, respectively. The first and second part of the data are a same part or different part of the data. The first wireless communication channel is established only when the user devices are within a predetermined distance from the equipment.

### TECHNICAL FIELD

The present document relates to a method and a system of transferring data between a server and an equipment which cannot establish a direct wireless communication with the server. Particularly, the present document relates to a method and system using at least two user devices as intermediate devices for wirelessly transferring data between a non-IoT equipment and a server.

### BACKGROUND

Internet of Things (IoT) devices are physical devices having processors, sensors, and etc., for performing certain functions, which can connect and exchange data with other devices and systems over the Internet, i.e. the global system of interconnected computer networks using the Internet protocol suite (TCP/IP) to communicate between networks and devices.

Since the IoT devices are typically designed to be able to connect to the Internet, the IoT devices can exchange data, including upload data and download data, with a remote device, such as a server. For example, an IoT system may comprise an IoT device having a direct access to the server (via the Internet) and having a direct access to a plurality of other devices, such as a smartphone, a computer, and a laptop. The other devices may also connect to the Internet.

Those non-IoT devices, which lack a connection to the Internet, may also have a need of exchanging data with another device. Such data exchanges may be useful and even necessary for those non-IoT devices. For example, a manufacturer may need to upgrade a firmware of its non-IoT devices to keep a good and robust performance of the non-IoT devices. Further, the manufacturer may want to retrieve the log files from the non-IoT devices for analysing their performance.

Different methods have been implemented for improving the data exchange of the non-IoT devices.

For example, the non-IoT devices and their infrastructure may be upgraded to provide the non-IoT devices with a direct connection to the Internet. However, this is infeasible as not only the upgrading is expansive, but also complicated when the infrastructure is involved.

For example, a direct wired connection between the non-IoT device and a second device, such as a USB storage device, can be used to exchange data, such as downloading the firmware of the non-IoT device from the USB storage device. However, this method is time consuming as for upgrading each one of the non-IoT devices, the USB storage device must be manually connected to the non-IoT device for downloading the firmware. Further, this method can even be difficult to implement if the physical access to the non-IoT device is restricted, e.g., if the non-IoT device for upgrading is hidden within another entity. Thus, even with the wired connection solution, the data exchange with the non-IoT devices cannot always be done timely without delay.

Thus, there is a need to improve the connectivity of the non-IoT devices eliminating or alleviating at least some of the above disadvantages.

### SUMMARY

It is an object of the present disclosure, to provide an improved method and system of transferring data between a server and an equipment which cannot establish a direct wireless communication with the server, which eliminates or alleviates at least some of the disadvantages of the prior art.

The invention is defined by the appended independent claims. Embodiments are set forth in the appended dependent claims, and in the following description and drawings.

According to a first aspect, there is provided a method of transferring data between a server and an equipment which cannot establish a direct wireless communication with the server. The method comprises:
at least two user devices, each establishing a first wireless communication channel with the equipment via a first wireless communication interface of said user device;
each of the at least two user devices establishing a second communication channel for connecting to the server via a second communication interface of said user device;
establishing an indirect wireless communication between the equipment and the server, via the at least two user devices, by using the first wireless communication channel and the second communication channel of any of the at least two user devices;
transferring data between the equipment and the server through the established indirect wireless communication;
wherein a first and a second part of the data are transferred between the equipment and the server via a first and a second user device of the at least two user devices, respectively;
wherein the first and second part of the data are a same part of the data, or different parts of the data;
wherein the data may comprise any of a firmware, a log file, usage metrics, a software package, a data stream, a remote management message, a digital signage;
wherein the first wireless communication channel is established only when said user device is within a predetermined distance from the equipment.

Firstly, the invention can provide data exchanges to an equipment which cannot establish a direct wireless communication with a remote device, by wirelessly connecting it to an intermediate device which can connect to the remote device. The invention can be applicable in many scenarios when there is a need to provide data exchanges for such equipment. For example, a fixed projector in a meeting room may upload its error log files to a server via a laptop of a user in the meeting room, wherein the laptop can connect to the Internet via an Ethernet cable. A loudspeaker in the meeting room may download a latest firmware from the server via a plurality of smartphones of the users in the meeting room, wherein the smartphones can connect to the Internet wirelessly via the mobile network or a Wi-Fi endpoint.

Secondly, the invention can simplify the maintenance of the equipment by providing an automatic data transferring (e.g., downloading firmware and uploading log files) using the user devices in close proximity to the equipment as the intermediate device. Thus, the maintenance of the equipment may be done automatically without user intervention.

Thirdly, the invention is easy to implement as it does not need to manually configure the user devices. Thus, the complicated settings of the user devices, such as the network configurations, the firewall, the routing tables, the Network Address Translation (NAT), etc., for establishing communication channels can be avoided. Further, even if the user has the competence to configure the user devices, these setting are typically not allowed on commercial user devices without administrative user rights.

Fourthly, the invention can eliminate or at least reduce the amount of user interventions needed for the data transferring.

The equipment and the user devices may be a part of a trusted group. For example, the user devices may be corporate mobile phones of the employees, actively managed as members of the trusted group by the corporate's IT department. The equipment, which is a device used within the corporate, may be added to the trusted group by the IT department only once. Then, the corporate mobile phones in close proximity to the equipment may automatically connect to the equipment and act as the intermediate devices, e.g., through an application (APP) installed on the user devices, for connecting to a server for exchanging data. The corporate mobile phones that move away from the equipment may automatically disconnect from the equipment and stop acting as the intermediate devices. The data transferring may be autonomously without involving the IT department or any user of the corporate mobile phones. The data transferring may run in the background without the users noticing it.

Fifthly, the invention can provide a robust and reliable data transferring. The data transferring is built on a distributed and ad-hoc nature of the user devices in close proximity to the equipment. Using at least two user devices as the intermediate devices may increase the reliability and the robustness of the data transfer. Further, adding new user devices or removing some of the existing user devices would not interrupt the data transferring from the point of view of the equipment.

A direct wireless communication may refer to that a wireless communication between two devices is established without using any intermediate device. For example, a Bluetooth communication between two smartphones is a direct wireless communication.

An indirect wireless communication may refer to that a communication between two devices is established by using an intermediate device, such as a proxy or gateway. For example, a wireless communication between a laptop and a server through a wireless router is an indirect wireless communication. Examples of the intermediate device include gateways, routers, routing switches, and wide area network (WAN) access devices, etc.

In the invention, each of the user devices is used as an intermediate device for establishing an indirect wireless communication between the equipment and the server.

The communication between the equipment and the user devices is wireless. The wireless communication can be any kind of short-range wireless connection, such as: infra-red, Zigbee, Bluetooth, Near-Field Communication (NFC), Wi-Fi, etc.

The communication between the server and the user devices may be wireless or wired. That is, the second communication channel may be a wired or wireless communication channel.

The transferred data may be a fragment of information which needs to be transferred between the equipment and the server.

The transferred data may comprise any of a firmware, a log file, usage metrics, a software package, a data stream, a remote management message, a digital signage, a scheduled maintenance action, or a calendar update, etc.

A firmware may be a specific class of computer software that provides a low-level control for a device. The firmware may contain basic functions of the device and may provide services to higher-level software such as operating systems. An example of the firmware is a BIOS of a personal computer. For less complex devices, the firmware may act as the device's operating system.

A log file may be a file that records events that occur in an operating system.

Usage Metrics may be measurements that reflect the real usage in terms of counts, such as page views, downloads of content, etc.

A software package may be an assemblage of files and information of those files packed together for providing certain functionality.

A data stream may be a sequence of digitally encoded signals used for transmitting or receiving information. The data stream may comprise any type of information, such as a video content for displaying on a display device, or an audio content. The information may be information of images, of documents, of recorded videos, of a real-time video captured by a camera, etc. For example, the transferred data may be a data stream of video data. The data steam may comprise audio data, and metadata including but not limited to events of an inputting device, e.g., a keyboard and a computer mouse.

A remote management message may comprise any request, response between two devices (a client and a server). The remote management message may comprise: a Remote Procedure Call (RCP) to send commands (e.g. configuration update) or do queries (e.g. device status). The remote management may be implemented by standard protocols like Simple Network Management Protocol (SNMP) or CPE WAN Management Protocol (CWMP), which is also known as Technical Report 069 (TR-069).

A digital signage may comprise data of HyperText Transfer Protocol (HTTP) or HyperText Transfer Protocol Secure (HTTPS) traffic, which is similar to web browsers retrieving web pages. Every time a user device is connected to the offline equipment, the offline equipment may update its digital signage such that the offline equipment may have “almost” up to date information, i.e. near-up-to-date information.

A size of a typical firmware may be in the order of hundreds of Megabytes. Since each user device may not stay in close proximity to the equipment for a period long enough for transferring the complete data, the data may be divided into smaller data chunks for transferring, e.g., by the peer-to-peer technology. The equipment may keep track of which data chunks it has uploaded and/or downloaded. Each user device may keep track of which data chunks it has uploaded and/or downloaded.

Scheduling of the transfer of each data chunk between the equipment and the multiple user devices can be done by a known protocol, such as the peer-to-peer protocol.

Transferring data between the equipment and the server may comprise uploading the data from the equipment to the server.

Transferring data between the equipment and the server may comprise downloading the data from the server to the equipment.

The at least two user devices may connect to the equipment simultaneously. The term “simultaneously” may refer to a time difference of more than one events, e.g., the at least two user devices connecting to the equipment, is less than 0.1 second, is less than 0.01 second, is less than 0.001 second.

The at least two user devices may establish their first wireless communication channel with the equipment simultaneously.

Alternatively, a first user device of the at least two user devices may connect to the equipment prior to a second user device of the at least two user devices connecting to the equipment.

The first user device may establish its first wireless communication channel with the equipment prior to second user device establishing its first wireless communication channel with the equipment.

A first time period for transferring the first part of the data and a second time period for transferring the second part of the data may be at least partially overlapping. The speed of the data transferring may be improved.

The first time period and the second time period may be nonoverlapping. The second user device may be used for transferring the second part of the data after the first user device finishing transferring the first part of the data.

The downloaded data may comprise a firmware of the equipment. The method may further comprise the equipment performing a firmware update using the downloaded data.

Uploading the data from the equipment to the server may comprise:
the equipment requesting the at least two user devices to upload the data to the server;
each of the at least two user devices connecting to the server through the second communication channel;
the equipment uploading the data to each of the at least two user devices through the first wireless communication channel;
each of the at least two user devices uploading the data to the server through the second communication channel.

Downloading the data from the server to the equipment may comprise:
the equipment requesting the at least two user devices to download the data from the server;
each of the at least two user devices connecting to the server through the second communication channel;
each of the at least two user devices downloading the data from the server through the second communication channel;
the equipment downloading the data from each of the at least two user devices through the first wireless communication channel.

Uploading the data from the equipment to the server may comprise the server sending a response to the at least two user devices indicating whether the uploading is successful or not. The at least two user devices may forward the response to the equipment.

Downloading the data from the server to the equipment may comprise the equipment sending a response to the at least two user devices indicating whether the downloading is successful or not. The at least two user devices forwarding the response to the server.

The method may comprise a proxy of the equipment creating a virtual network interface for each of the at least two user devices.

The method may comprise:
the first user device establishing its first wireless communication channel with the proxy;
the first user device establishing its second communication channel connecting to the server;
establishing a first indirect wireless communication for transferring the data between the equipment and the server via the first user device, by using the first wireless communication channel and the second communication channel established by the first user device;
transferring the first part of the data between the equipment and the server through the first indirect wireless communication.

The method may comprise:
the second user device establishing its first wireless communication channel with the proxy;
the second user device establishing its second communication channel connecting to the server;
establishing a second indirect wireless communication for transferring the data between the equipment and the server via the second user device, by using the first wireless communication channel and the second communication channel established by the second user device;
transferring the second part of the data between the equipment and the server through the second indirect wireless communication.

The second indirect wireless communication may be established after the first indirect wireless communication is terminated.

The method may comprise:
the first user device establishing its first wireless communication channel with the proxy;
the first user device establishing its second communication channel connecting to the server;
establishing a communication session comprising a first flow for transferring the data between the equipment and the server via the first user device, by using the first wireless communication channel and the second communication channel established by the first user device;
the second user device establishing its first wireless communication channel with the proxy;
the second user device establishing its second communication channel connecting to the server;
establishing a second flow for transferring the data between the equipment and the server via the second user device, by using the first wireless communication channel and the second communication channel established by the second user device;
adding the second flow to the communication session;
transferring the data between the equipment and the server by using both the first and second flow of the established communication session.

The method may comprise:
the proxy establishing a first tunnel between the proxy and the first user device by negotiating with the first user device;
the equipment sending an initial request (SYN) to the first user device via the proxy through the first tunnel for initiating the first flow of the communication session towards the server;
the first user device forwarding the initial request (SYN) to the server through its second communication channel;
the server receiving the initial request (SYN), and sending an initial response (SYN+ACK) to the first user device through the second communication channel of the first user device, for indicating acceptance of the first flow of the connection session initiated by the equipment and for initiating the first flow of the communication session towards the equipment; the first user device forwarding the initial response (SYN+ACK) to the proxy;
after receiving the initial response (SYN+ACK), the equipment sending an acknowledgement (ACK) to the first user device via the proxy through the first tunnel for indicating acceptance of the first flow of the connection session initiated by the server;
the first user device forwarding the acknowledgement (ACK) to the server through its second communication channel;
wherein after the server receives the acknowledgement (ACK), the communication session comprising the first flow for transferring the data between the equipment and the server via the first user device, by using the first wireless communication channel and the second communication channel established by the first user device, is established.

The method may comprise:
the equipment sending a first data (DATA) to the first user device via the proxy through the first tunnel; and
the first user device forwarding the first data (DATA) to the server through its second communication channel;
after receiving the first data (DATA), the server sending a response to the first user device indicating whether the first data is successful received or not.

The first user device may forward the response to the equipment.

The method may comprise:
the server sending a second data through the second communication channel of the first user device to the first user device; and
the first user device forwarding the second data to the equipment via the proxy through the first tunnel;
after receiving the second data, the equipment sending a response to the first user device indicating whether the second data packet is successful received or not.

The first user device may forward the response to the server.

The method may comprise:
after the second user device establishing its first wireless communication channel with the proxy, the proxy sending a first message (ADD_ADDR) to the server via the first user device through the first tunnel, for informing the existence of the second user device;
the proxy establishing a second tunnel between the proxy and the second user device by negotiating with the second user device;
the proxy sending an initial request (SYN) to the second user device through the second tunnel for initiating the second flow of the communication session towards the server;
the second user device forwarding the initial request (SYN) to the server via its second communication channel;
the server receiving the initial request (SYN), and sending an initial response (SYN+ACK) to the second user device through the second communication channel of the second user device, for indicating acceptance of the second flow of the connection session initiated by the equipment and for initiating the second flow of the communication session towards the equipment;
the second user device forwarding the initial response (SYN+ACK) to the proxy;
after receiving the initial response (SYN+ACK), the proxy sending an acknowledgement (ACK) to the second user device through the second tunnel for indicating acceptance of the second flow of the connection session initiated by the server;
the second user device forwarding the acknowledgement (ACK) to the server through its second communication channel;
wherein after the server receives the acknowledgement (ACK), the second flow for transferring the data between the equipment and the server via the second user device, by using the first wireless communication channel and the second communication channel established by the second user device is established.

The communication session may be a TCP communication session. The first or the second flow may be a TCP flow of a TCP communication session.

The method may comprise when the established first wireless communication channel of the first user device is interrupted or terminated, terminating the first flow of the established communication session.

Terminating the first flow may comprises the proxy sending a second message (REMOVE_ADDR) to the server to terminating the first flow, via the second user device through the second tunnel.

The method may comprise when the first and/or second flow is terminated, the proxy terminating the first and/or second tunnel, respectively.

The communication session may be a Transmission Control Protocol, TCP, session.

Any of the initial request, the initial response, the response, the first message, the second message and the acknowledgement, may comprise a TCP segment.

The method may comprise the proxy modifying a header of the TCP segment before forwarding it further to the first or second user device.

The first tunnel and/or the second tunnel may be a transparent proxy tunnel.

The method may comprise authenticating the at least two user devices (3, 4, 5) before establishing the first wireless communication channel, comprising comparing an identity of the at least two user devices with identities of a first trust list.

The method may comprise authenticating the equipment before establishing the first wireless communication channel, comprising comparing an identity of the equipment with identities of a second trust list.

The first and second trust list may be the same or different trust lists.

According to a second aspect, there is provided a system for transferring data between a server and an equipment which cannot establish a direct wireless communication with the server. The system comprises the equipment, the server, and at least two user devices. Each of the at least two user devices is configured to establish a first wireless communication channel with the equipment via a first wireless communication interface of said user device; establish a second communication channel for connecting to the server via a second communication interface of said user device. An indirect wireless communication between the equipment and the server is established, via the at least two user devices, by using the first wireless communication channel and the second communication channel of any of the at least two user devices, for transferring data between the equipment and the server. A first and a second part of the data are transferred between the equipment and the server via a first and a second user device of the at least two user devices, respectively. The first and second part of the data are a same part of the data, or different parts of the data. The data may comprise any of a firmware, a log file, usage metrics, a software package, a data stream, a remote management message, a digital signage. The first wireless communication channel is established only when said user device is within a predetermined distance from the equipment.

According to a third aspect, there is provided a method of transferring data between a server and an equipment which cannot establish a direct wireless communication with the server, wherein at least one user device is capable of transferring a first data with the equipment by using a first wireless communication channel between the equipment and the at least one user device. The method comprises: the at least one user device establishing a second communication channel for transferring data with the server; estimating a capacity of the first wireless communication channel for transferring the second data between the equipment and the at least one user device; and based on the estimated capacity, transferring the second data between the equipment and the server via the at least one user device, by using the first wireless communication channel and the second communication channel, based on the estimated capacity.

The inventive concept is to piggyback one or more existing wireless connection(s) between the equipment and one or more user devices, to enable a wireless data transfer functionality for the equipment which cannot establish a direct wireless communication with the server. In other words, besides the data that the existing wireless connection(s) is allocated for transferring, additional data is also transferred by using the existing wireless connection(s).

The term “piggyback” in the application may refer to using an existing wireless communication channel for transferring additional data (the second data), which the existing channel is not originally allocated for.

Transferring the additional data (the second data) by using the existing wireless connection(s) may be “transparent” to a user using the first wireless communication channel for transferring data (the first data).

The term “transparent” may refer to that the user device and/or the user using the existing wireless connection(s) would not notice any changes to the data transfer (the first data) or to the existing wireless connection(s), caused by the transfer of the additional data (the second data).

The term “transparent” may refer to that any changes to the data transfer (the first data) and/or to the existing wireless connection(s), caused by the transfer of the additional data (the second data), would not exceed an allowable limit, such that the impact to the data transfer (the first data) and/or to the existing wireless connection(s) would be minimised, or at least be controllable.

The capacity of the first wireless communication channel may comprise any of: a bandwidth, a throughput, a latency, a bit-error rate, BER, and a packet-error rate, PER, of the first wireless communication channel.

The step of estimating a capacity of the first wireless communication channel for transferring the second data between the equipment and the at least one user device may comprise:
estimating the capacity of the first wireless communication channel for transferring the second data between the equipment and the at least one user device based on a property of the first wireless communication channel.

The step of estimating a capacity of the first wireless communication channel for transferring the second data between the equipment and the at least one user device may comprise:
estimating the capacity of the first wireless communication channel for transferring the second data between the equipment and the at least one user device based on a requirement of transfer of the second data.

The property of the first wireless communication channel may comprise a physical property of the first wireless communication channel, such as a type of the channel and a physical connection of the channel.

The type of the first wireless communication channel may be, e.g., a simplex channel, a multiplexed channel, an upstream channel, a downstream channel, a broadcast channel, etc.

The property of the first wireless communication channel may comprise a usage information of the first wireless communication representing a usage of the first wireless communication channel for transferring the first data. Based on the usage of the first wireless communication channel for transferring the first data, the capacity of the first wireless communication channel that can be used to transfer the second data may be estimated.

The usage information may be a current usage of the first wireless communication for transferring the first data, or an estimated usage of the first wireless communication for transferring the first data in a future time point. It is advantageous to estimate the capacity of the first wireless communication channel that can be used to transfer the second data in the future, as it may facilitate the planning of the resources (e.g., the user devices) in advance.

The estimated usage may be generated based on information about a user pattern. For example, when the user pattern indicates that a large number of first data transfer between the equipment and the user device is going to happen, the estimated usage may be used to prevent too much capacity of the first wireless communication channel being used for transferring the second data.

The requirement of transfer of the second data may comprise information related to the second data, such as the content of the second data, the size of the second data, the priority of the second data, etc.

The property of the first wireless communication channel may be static or dynamic.

The requirement of transfer of the second data may be static or dynamic.

The property of the first wireless communication channel may be static. For example, the property may be a bandwidth. The bandwidth of the first wireless communication channel may be 100 Mbit/s and the usage of the first wireless communication channel for transferring the first data may be pre-determined to be 80 Mbit/s. Then, the first wireless communication may be able to provide a bandwidth up to 20 Mbit/s for transferring the second data, irrespective of the actual bandwidth for transferring the first data.

The property of the first wireless communication channel may be dynamic. The property information of the first wireless communication channel may be determined based on a current channel performance measure. For example, the bandwidth of the first wireless communication channel may be 100 Mbit/s and the current usage of the first wireless communication channel for transferring the first data is only 10 Mbit/s. Then, the first wireless communication channel may be able to provide a bandwidth up to 90 Mbit/s for transferring the second data. Thus, the property of the first wireless communication channel being dynamic may provide an improved flexibility, and a reduced waste of resource.

The requirement of transfer of the second data may be static. For example, the requirement may be pre-determined to be 10 Mbit/s for transferring the second data.

The requirement of transfer of the second data may be dynamic. For example, the requirement may be dynamically determined based on content of the second data.

Depending on whether the property of the first wireless communication channel, and the requirement of transfer of the second data is dynamic or static, the estimated capacity may be dynamic or static.

The method may comprise when a priority of the transfer of the second data is high, or when a priority of the transfer of the second data is higher than a priority of transfer of the first data, prioritising the transfer of the second data over the transfer of the first data.

The method may comprise sending a request to the at least one user device for changing the transfer of the first data for prioritising the transfer of the second data.

For example, when the second data comprises an urgent firmware update for upgrading the equipment, the transfer of the second data may have a high priority and thus, be prioritised. A request may be sent to the at least one user device 3, 4, 5 for changing the transfer of the first data for prioritising the transfer of the second data. For example, the bandwidth used for transferring the first data may be temporally reduced, and the bandwidth used for transferring the second data may be temporally increased.

The at least one user device may comprise a first user device and a second user device. The first user device may be capable of transferring data with the equipment by using the first wireless communication channel between the equipment and the first user device. The second user device may be capable of transferring data with the equipment by using the first wireless communication channel between the equipment and the second user device. The step of estimating a capacity of the first wireless communication channel for transferring the second data between the equipment and the at least one user device may comprise:
estimating a first capacity of the first wireless communication channel for transferring the second data between the equipment and the first user device; and
estimating a second capacity of the first wireless communication channel for transferring the second data between the equipment and the second user device.

The step of transferring the second data between the equipment and the server via the at least one user device may comprise:
transferring a first part of the second data between the equipment and the server via the first user device, based on the first estimated capacity; and
transferring a second part of the second data between the equipment and the server via the second user device, based on the second estimated capacity.

The first and second part of the second data are a same part of the second data, or different parts of the second data.

When there are at least two user devices, the second data may be transferred by more than one first wireless communication channel (via more than one user device). This may improve the robustness of the transfer of the second data. This may improve the speed of the transfer of the second data.

The second data may comprise any of a firmware, a log file, usage metrics, a software package, a data stream, a remote management message, and a digital signage.

According to a fourth aspect, there is provided a system of transferring data between a server and an equipment which cannot establish a direct wireless communication with the server, the system comprising the equipment, the server, and at least one user device. The at least one user device is configured to
transfer a first data with the equipment by using a first wireless communication channel between the equipment and the at least one user device, and
establish a second communication channel for transferring data with the server.

A capacity of the first wireless communication channel for transferring the second data between the equipment and the at least one user device is estimated. The second data is transferred between the equipment and the server via the at least one user device, by using the first wireless communication channel and the second communication channel, based on the estimated capacity.

The system may comprise a channel control module configured to estimate the capacity of the first wireless communication channel for transferring the second data between the equipment and the at least one user device.

The channel control module may be further configured to configure the first wireless communication channel based on the estimated capacity for transferring the second data.

The channel control module may be further configured to modulate a command for sending and/or receiving the second data.

The channel control module may be further configured to start and/or terminate transferring of the second data.

For example, any property of the first wireless communication channel, including but not limited to a data transfer rate, a size, a type, a duplication, a priority of commands, and data or data packets may be configured.

When there are at least two user devices, the channel control module may configure more than one first wireless communication channel to transfer the second data.

### BRIEF DESCRIPTION OF THE DRAWINGS

FIGS. 1a and 1b are two examples of a system of transferring data between a server and an equipment.

FIG. 2 is an example of a system of transferring data between a server and an equipment.

FIG. 3 is an example of a system of transferring data between a server and an equipment.

FIG. 4 is an example of a method of transferring data between a server and an equipment.

FIG. 5 is an example of a method of transferring data between a server and an equipment.

FIG. 6a is a sequence diagram of an example of a method of transferring data between a server and an equipment.

FIG. 6b is a sequence diagram of an example of a method of transferring data between a server and an equipment.

FIG. 7 is a sequence diagram of an example of a method of transferring data between a server and an equipment.

FIGS. 8a and 8b are examples of a system of transferring data between a server and an equipment.

FIGS. 9a-9c are examples of a system of transferring data between a server and an equipment.

### DESCRIPTION OF EMBODIMENTS

The present invention will now be described more fully hereinafter with reference to the accompanying drawings, in which currently preferred embodiments of the invention are shown.

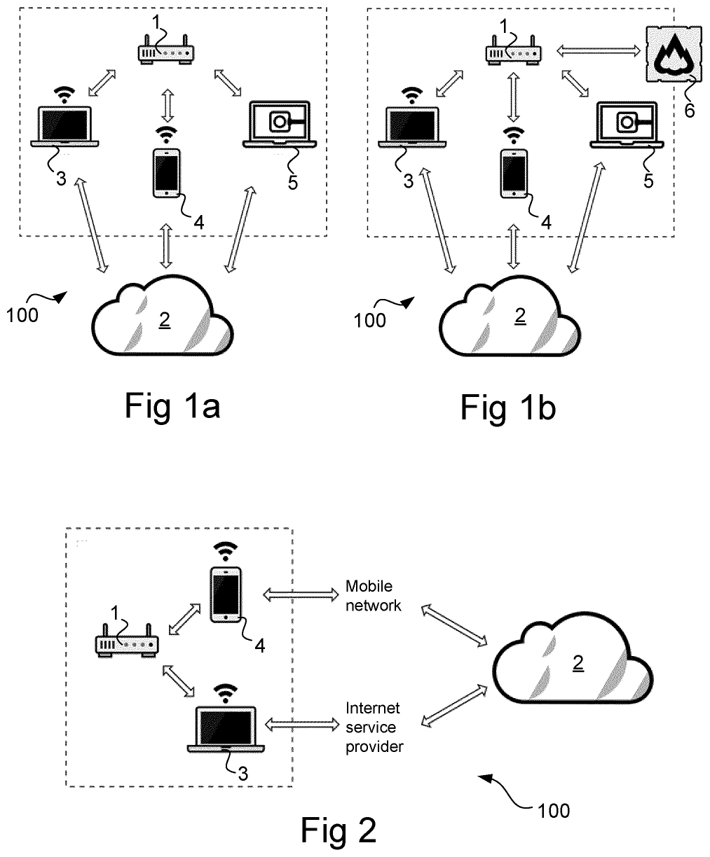

FIGS. 1a and 1b are two examples of a system 100. The system 100 of both examples comprises an equipment 1 which cannot establish a direct wireless communication with a server 2.

In the example of FIG. 1a, the equipment 1 cannot establish a direct wireless communication with the server 2 as the equipment 1 has no direct network connection. For example, the equipment may be a non-IoT device, which does not have any hardware for enable the direct wireless connection to the server 2 via the Internet.

In the example of FIG. 1b, the equipment 1 cannot establish a direct wireless communication with the server 2 as a direct network connection may be blocked, e.g., by a firewall 6. For example, the equipment 1 may be an IoT device, but its direct wireless connection to the server 2 is blocked, e.g., for security reasons.

The equipment 1 may be an office equipment, such as a printer, a scanner, a display, a projector, and a loudspeaker, etc. The equipment 1 may be a smart home device, such as a smart lighting device, a monitoring camera, and a smart coffee machine, etc.

The system 100 comprises at least two user devices. In the example of FIGS. 1a-1b, the system 100 comprises three user devices 3, 4, 5.

Each user device 3, 4, 5 comprises a first wireless communication interface. The user device 3, 4, 5 is configured to establish a first wireless communication channel with the equipment 1 via the first wireless communication interface.

The first wireless communication channel is established only when the user device 3, 4, 5 is within a predetermined distance from the equipment. The first wireless communication channel may be established only when the user device 3, 4, 5 is in close proximity to the equipment 1. The predetermined distance may be 20 meters, 15 meters, 10 meters, 8 meters, 5 meters, or 1 meter. When the user device 3, 4, 5 is moved away from the equipment 1, the user device 3, 4, 5 will be disconnected from the equipment 1, and the established first wireless communication channel will be ended.

The first wireless communication interface may be an interface of a short-range radio frequency (RF) communication. The first wireless communication channel may be a short-range RF communication channel.

The first wireless communication channel may be a Wi-Fi communication channel. The equipment 1 may act as a Wi-Fi Access Point. The user device 3, 4, 5 may act as a Wi-Fi Access Point.

Both the equipment and the user devices may be connected to a same Local Network, such as WLAN.

The first wireless communication channel may be an Ad-Hoc wireless connection channel, e.g., Bluetooth and Wi-Fi Direct.

Each user device 3, 4, 5 comprises a second communication interface. The user device 3, 4, 5 is configured to establish a second communication channel for connecting to the server 2 via the second communication interface.

The second communication interface may be an interface of a long-range RF communication, such as interface for cellular network (mobile network).

The second communication interface may be an interface of a wired communication, such as interface for an Ethernet cable.

The user device 3 may be a laptop. The laptop 3 may comprise two different communication interfaces for respectively connecting to other devices via Wi-Fi and Bluetooth.

The user device 4 may be a smartphone. The smartphone 4 may comprise two different communication interfaces for respectively connecting to other devices via Wi-Fi and a cellular network (3G, 4G, or 5G).

The user device 5 may be a desk computer. The desk computer 5 may comprise two different communication interfaces for respectively connecting to other devices via Wi-Fi and an Ethernet cable.

Each of the user devices 3, 4, 5 may include a processing circuit, such as a central processing unit (CPU), microcontroller, or microprocessor.

Each of the user devices 3, 4, 5 may comprise a memory. The processing circuit may be configured to execute program codes stored in the memory, in order to carry out functions and operations of the user devices 3, 4, 5.

The memory may be one or more of a buffer, a flash memory, a hard drive, a removable medium, a volatile memory, a non-volatile memory, a random access memory (RAM), or another suitable device. In a typical arrangement, the memory may include a non-volatile memory for long term data storage and a volatile memory that functions as system memory for the user devices 3, 4, 5. The memory may exchange data with the processing circuit over a data bus. Accompanying control lines and an address bus between the memory and the processing circuit also may be present.

Functions and operations of the user devices 3, 4, 5 may be embodied in the form of executable logic routines (e.g., lines of code, software programs, etc.) that are stored on a non-transitory computer readable medium (e.g., the memory) of the user devices 3, 4, 5 and are executed by the processing circuit.

The executable logic routines may be in the form of an application (APP). The APP may be stored in the memory of the user devices 3, 4, 5.

Furthermore, the functions and operations of the user devices 3, 4, 5 may be a stand-alone software application or form a part of a software application that carries out additional tasks related to the user devices 3, 4, 5. The described functions and operations may be considered a method that the corresponding device is configured to carry out. Also, while the described functions and operations may be implemented in software, such functionality may as well be carried out via dedicated hardware or firmware, or some combination of hardware, firmware and/or software.

Each of the user devices 3, 4, 5 may comprise a user interface. The user interface may be configured to output data and to receive data from one or several input devices. The input device may be a computer mouse, a keyboard, a track ball, a touch screen, or any other input device. The user interface may send the received data to the processing circuit for further processing.

Each of the user devices 3, 4, 5 may have an APP installed for controlling the data transferring through the user devices 3, 4, 5. The APP may be a software program running on the user devices 3, 4, 5. The APP may run in the background.

The APP may be configured to perform any of the following functions:
1) configuring the first and second communication interface of the user devices 3, 4, 5;
2) establishing the first and second communication channel;
3) scheduling the data transfer;
4) forwarding the data to a destination; and
5) keeping track of the transferred data.

Comparing to a gateway device, which typically passing through all the data traffic, the APP may be configured to selectively pass through only certain types of data, such as only allowing data relating to a firmware and log files. This may improve the security of the data transferring.

The server 2 may be a computer hardware or software that provides functionality for other programs or devices (clients). Servers can provide various functionalities (services), such as sharing data or resources among multiple clients, or performing computation for the clients. A single server can serve multiple clients, and a single client can use multiple servers.

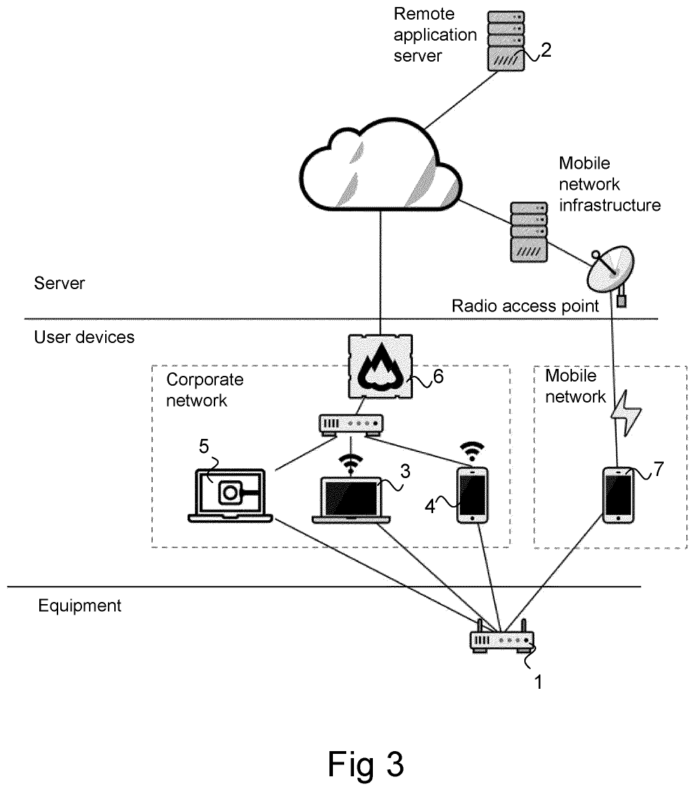

The server may be provided distantly from its clients. For example, the server 2 may be provided within a same building of the equipment 1, in a same room or in different rooms. The server may be provided remotely from its clients, i.e. there is a long distance in space between the server and its clients, at least tens of kilometres. For example, the server 2 may be located remotely from the equipment 1 and the user device 3, 4, 5, as shown in FIGS. 1-2. In FIGS. 1-2, the server 2 is symbolised as a cloud for simplification.

The server 2 may be a database server, a file server, a mail server, a print server, a web server, or an application server. For example, the firmware may be stored on the server 2 for downloading. The server 2 may collect the uploaded log files and analyse them or forward them to a different device for analysing.

For example, the server 2 may be a part of a company network that communicates with the user devices of the employees.

An indirect wireless communication between the equipment 1 and the server 2 is established by using the first wireless communication channel and the second communication channel established by each of the user devices 3, 4, 5. Each of the user device 3, 4, 5 is acting as the intermediate device.

The system for transferring data will be discussed in more detail by using the following example.

A super user (e.g., IT department) may install the APP on each user device 3, 4, 5 of the employees. The user device 3, 4, 5 may be added into a trusted group.

The super user may add a plurality of equipment 1 into the same or a different trusted group.

The super user may store the latest firmware on the server 2 for downloading to the plurality of equipment 1.

The super user may authorise some or all of the user devices 3, 4, 5 for acting as intermediate devices for downloading the firmware to the plurality of equipment 1.

The authorisation may be transferred to the APPs of user devices 3, 4, 5. Alternatively, or in combination, the super user may modify the trusted group to reflect the changes of the authorisation.

When the user devices 3, 4, 5 are within the predetermined distance from the equipment 1, the indirect wireless communication between the equipment 1 and the server 2 may be established via the APP of the user devices 3, 4, 5.

Before downloading the firmware, the APP may check with the equipment 1 and/or the server 2 to confirm that it is the correct firmware to be downloaded.

The firmware may be downloaded to the equipment 1 from the server 2 via the user device 3, 4, 5, e.g., in the form of small data chunks, e.g., by using to the peer-to-peer technology. Thus, at least two user devices 3, 4, 5 can act as the intermediate device and contribute to the data transfer at the same time.

The users (e.g., employees) of the user devices 3, 4, 5 do not need to take any action to either initiate or terminate the data transfer. Rather, the data transferring through the user devices 3, 4, 5 should be “transparent”, as the APP acts autonomously in the background.

The equipment 1 may keep track of the integrity of the transferred data, e.g., using blockchain technology.

The APP may keep track of the integrity of the transferred data between the equipment 1 and the server 2.

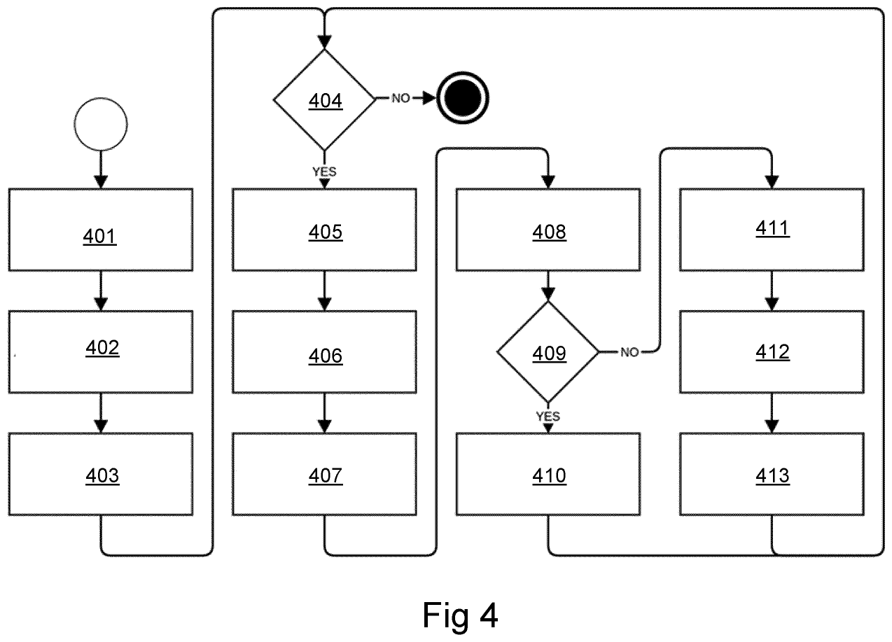

FIG. 2 is an example of a system 100 similar to the examples of FIGS. 1a-1b. However, the system of FIG. 3 comprises only two user devices 3, 4.

The first user device 3 is a computer being connected to the server 2 through an Internet service provider.

The second user device 4 is a smartphone being wirelessly connected to the server 2 through the cellular network (mobile network).

Two separate indirect wireless communications are established between the server 2 and the equipment 1, wherein one is through the first user device 3 and the other one is through the second user device 4.

Since there are two separate indirect wireless communications established between the server 2 and the equipment 1, even if the first user device 3 is disconnected from the equipment 1, the data transferring between the equipment 1 and the server 2 is uninterrupted from the equipment's point of view. Thus, the data transferring is robust.

New user devices may be connected to the equipment 1 and new indirect wireless communications may be established. The speed of the data transferring may be increased.

In connection with FIG. 3, the indirect wireless communication between the equipment and the server will be discussed in more detail.

In FIG. 3, the system 10 is divided into three portions.

The bottom portion comprises the equipment 1, which cannot establish a direct wireless communication with the server 2.

The middle portion comprises the user devices 3, 4, 5, 7.

The user devices 3, 4, 5 may connect to a router of a corporate network for connecting to the server 2 through the firewall 6. Thus, the equipment 1 may connect with the user devices connecting to the corporate network for transferring data with the server 2.

The user device 7 may connect to a mobile network for connecting to the server 2. Thus, the equipment 1 may connect with the user device 7 for transferring data with the server 2 via the mobile network.

The top portion comprises the server 2.

The corporate network of the middle portion may directly connect to the server 2, e.g., via cloud. The server 2 may be a remote application server, as shown in FIG. 3.

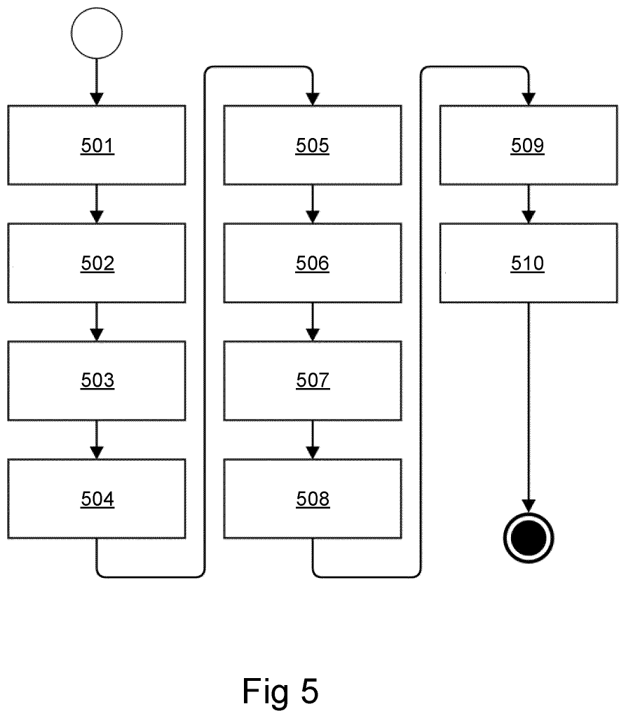

The mobile network may connect to the server 2 via a radio access point, e.g., a mobile base station, and other mobile network infrastructure, to connect to the server 2. In connection with FIG. 4, the method of transferring data between the server 2 and the equipment 1 will be discussed in more detail.

The method comprises each of at least two user devices 3, 4, 5, 7 establishing a first wireless communication channel with the equipment 1 via a first wireless communication interface of the user device 3, 4, 5, 7.

The step of each user device 3, 4, 5, 7 establishing a first wireless communication channel may comprise any of:
step 401, the user device 3, 4, 5, 7 connecting to the equipment 1;
step 402, activating an APP installed on the user device 3, 4, 5, 7; and
step 403, establishing the first wireless communication channel between the user device 3, 4, 5, 7 (or the APP of the user device 3, 4, 5, 7) and the equipment 1 (or a controller of the equipment 1).

The controller may be a software or a hardware of the equipment 1 for controlling connections of the equipment 1 with other devices.

Using the APP for establishing the first wireless communication channel and/or the second communication channel can separate the function of the user device 3, 4, 5, 7 as the intermediate device from its normal functions, such as calling functions. Thus, the initiation and termination of the first and/or second communication channels by the APP will not interfere with other functions of the user device 3, 4, 5, 7.

The method of transferring data between the server 2 and the equipment 1 may comprise:
step 404, determining whether there is a command in a command queue.

The command may be a command sent by the equipment 1 (or the controller of the equipment 1) to the user device 3, 4, 5, 7 (or the APP of the user device 3, 4, 5, 7) via the established first wireless communication channel.

If there is no command, the method may be terminated. The established first wireless communication channel may be terminated.

If there is at least one command, the method of transferring data between the server 2 and the equipment 1 may comprise:
step 405, retrieving the first command in the command queue.

The command may be an upload command or a download command.

The upload command may be that the equipment 1 (or the controller of the equipment 1) requests the user device 3, 4, 5, 7 (or the APP of the user device 3, 4, 5, 7) to upload the data from the equipment 1 to the server 2 by using the established indirect wireless communication.

The download command may be that the equipment 1 (or the controller of the equipment 1) requests the user device 3, 4, 5, 7 (or the APP of the user device 3, 4, 5, 7) to download the data from the server 2 to the equipment 1 by using the established indirect wireless communication.

The method of transferring data between the server 2 and the equipment 1 comprises:
step 406, each of the at least two user devices 3, 4, 5, 7 (or the APPs of the user devices 3, 4, 5, 7) establishing a second communication channel for connecting to the server 2 via a second communication interface of the user device 3, 4, 5, 7.

The method of transferring data between the server 2 and the equipment 1 comprises a step of establishing an indirect wireless communication between the equipment 1 and the server 2, via each of the at least two user devices 3, 4, 5, 7, by using the first wireless communication channel and the second communication channel.

The method of transferring data between the server 2 and the equipment 1 comprises:
step 407, transferring data between the equipment 1 and the server 2 through the established indirect wireless communication.

The equipment 1 may upload the data to and/or download the data from the server 2 according to the command.

A part of the same data may be transferred (e.g., uploaded from the equipment 1 to the server 2 and/or download from the server 2 to the equipment 1) between the equipment 1 and the server 2 via different user devices 3, 4, 5, 7.

The same part of the data may be transferred via different user devices 3, 4, 5, 7. This may increase robustness of the data transferring at a cost of increased redundancy and reduced throughput.

Different parts of the data may be transferred via the different user devices 3, 4, 5, 7. This may increase throughput of the established indirect wireless communication. In other words, the data transferring may have a higher speed and may be completed in a shorter time.

The method of transferring data between the server 2 and the equipment 1 may comprise:
step 408, the user device 3, 4, 5, 7 (or the APP of the user device 3, 4, 5, 7) and the server 2 stops the data transferring.

The method of transferring data between the server 2 and the equipment 1 may comprise:
step 409, determining whether there was any error happened, e.g., a network error.

If there was an error happened, the method of transferring data between the server 2 and the equipment 1 may comprise:
step 410, the equipment 1 (or the controller of the equipment 1) sending the previous command again and returning to the step 404.

If there was no error happened, the method of transferring data between the server 2 and the equipment 1 may comprise:
step 411, the server 2 sending a response to the at least two user devices 3, 4, 5, 7 (or the APPs of the user devices 3, 4, 5, 7) indicating that the uploading is successful, and/or the equipment 1 (or the controller of the equipment 1) sending a response to the at least two devices 3, 4, 5, 7 (or the APPs of the user devices 3, 4, 5, 7) indicating that the downloading is successful.

The method of transferring data between the server 2 and the equipment 1 may comprise:
step 412, the user devices 3, 4, 5, 7 (or the APPs of the user devices 3, 4, 5, 7) forwarding the response of the server 2 to the equipment 1 (or the controller of the equipment 1), and/or the user devices 3, 4, 5, 7 (or the APPs of the user devices 3, 4, 5, 7) forwarding the response of the equipment 1 (or the controller of the equipment 1) to the server 2.

The method of transferring data between the server 2 and the equipment 1 may comprise:
step 413, the equipment 1 (or the controller of the equipment 1) keeping track of the uploaded and/or the downloaded data.

The data may a fragment, i.e. a data chunk, of information which needs to be transmitted between the equipment 1 and the server 2. The equipment 1 (or the controller of the equipment 1) may record which part of the information has been uploaded and/or downloaded.

The equipment 1 (or the controller of the equipment 1) may check whether the information which needs to be transmitted between the equipment 1 and the server 2 is completely transmitted.

The user devices 3, 4, 5, 7 (or the APPs of the user devices 3, 4, 5, 7) may check whether the information which needs to be transmitted between the equipment 1 and the server 2 is completely transmitted.

When the downloaded data is a firmware of the equipment 1, the equipment 1 may perform a firmware update using the downloaded firmware.

An entirely automatic firmware update for the equipment 1 can be achieved. No user intervention is needed for the firmware update.

When an existed APP is uninstalled from any of the user devices 3, 4, 5, 7 during the data transferring, said user device may stop acting as the intermediate device. The equipment 1 (or the controller of the equipment 1) may resend the command.

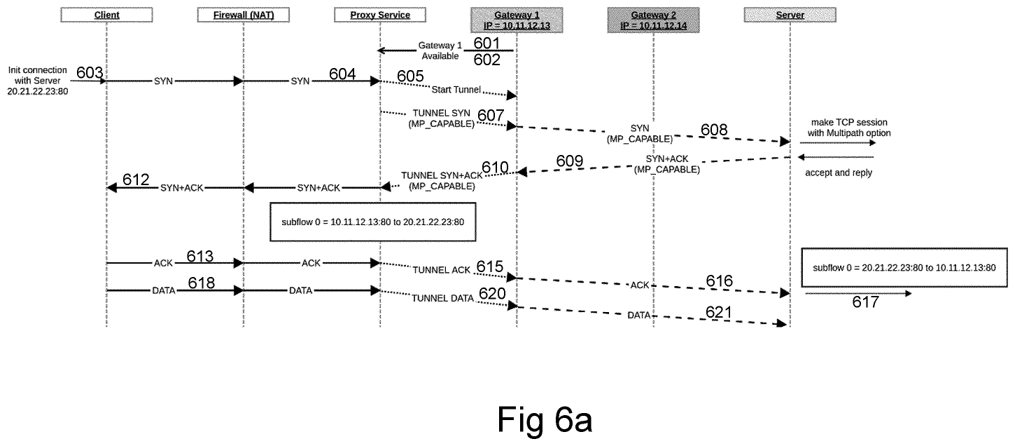

In connection with FIG. 5, the method of transferring data between the server 2 and the equipment 1 will be discussed in more detail.

The steps 501 and 502 are the same as the steps 401 and 402.

The method of transferring data between the server 2 and the equipment 1 may comprise:
step 503, establishing the first wireless communication channel between each of the user devices 3, 4, 5, 7 (or the APPs of the user devices 3, 4, 5, 7) and a proxy of the equipment 1.

The proxy of the equipment 1 may create a virtual network interface for each of the at least two user devices 3, 4, 5, 7.

The proxy may be a software or an application which acts as an intermediary between a client (e.g., the equipment 1) requesting a resource and an end point (e.g., the user devices 3, 4, 5, 7) providing the resource. Instead of connecting directly to the end point, the client directs its request to the proxy. The proxy may modify the request and perform required network transactions. The proxy may simplify the request and provide additional benefits, such as load balancing, privacy, or security. The proxy may also be referred as a proxy server.

The proxy may be a transparent proxy which does not require any special client configuration. The transparent proxy does not modify the request or response beyond what is required for a proxy authentication and identification. That is, the client does not need to be aware of the existence of the proxy, which is “transparent” to the client.

The tunnel between the proxy and the user device 3, 4, 5, 7 (or the APP of the user device 3, 4, 5, 7) may be a transparent proxy tunnel.

The proxy may create and expose the virtual network interface for each of the at least two user devices 3, 4, 5, 7, such that the equipment 1 can implement a multipath wireless communication (e.g., a multipath Transmission Control Protocol, TCP, communication) with the at least two user devices 3, 4, 5, 7. In other words, the equipment 1 may independently communicate with each of the at least two user devices 3, 4, 5, 7.

By using a transparent proxy network setup, the equipment 1 can initiate a connection with a device on the Internet without knowing that the connection goes over the transparent proxy.

The multipath TCP communication may be implemented by a kernel driver of the Operating System (OS) of the equipment 1.

The first wireless communication channels may be controlled by the multipath TCP protocol.

The method of transferring data between the server 2 and the equipment 1 may comprise:
step 504, the equipment 1 initiating a TCP session with the server 2.

For the TCP session, a connection between the client (e.g., equipment 1) and the end point (e.g., the server 2) should be established before data can be sent. The server 2 must listen for connection requests from the equipment 1 before a connection can be established. The TCP session typically uses a three-way handshake.

The method of transferring data between the server 2 and the equipment 1 may comprise one or more of the following steps 505-510:
step 505, a firewall of the equipment 1 intercepting the TCP session, and forwarding the intercepted TCP segments to the proxy of the equipment 1;
step 506, the proxy of the equipment 1 negotiating a tunnel, e.g., a transparent proxy tunnel, between the proxy and each of the user devices 3, 4, 5, 7 (or the APPs of the user devices 3, 4, 5, 7);
step 507, the proxy of the equipment 1 forwarding the TCP segments to each of the user devices 3, 4, 5, 7 (or the APPs of the user devices 3, 4, 5, 7);
step 508, each of the user devices 3, 4, 5, 7 (or the APPs of the user devices 3, 4, 5, 7) establishing a connection, e.g., a Transport Layer connection, with the server 2;
step 509, each of the user devices 3, 4, 5, 7 (or the APPs of the user devices 3, 4, 5, 7) forwarding the TCP segments to the server 2, and relaying all the returning TCP segments from the server 2 to the proxy of the equipment 1;
step 510, when the TCP session is terminated, each of the user devices 3, 4, 5, 7 (or the APPs of the user devices 3, 4, 5, 7) and the proxy of the equipment 1 terminating the tunnel.

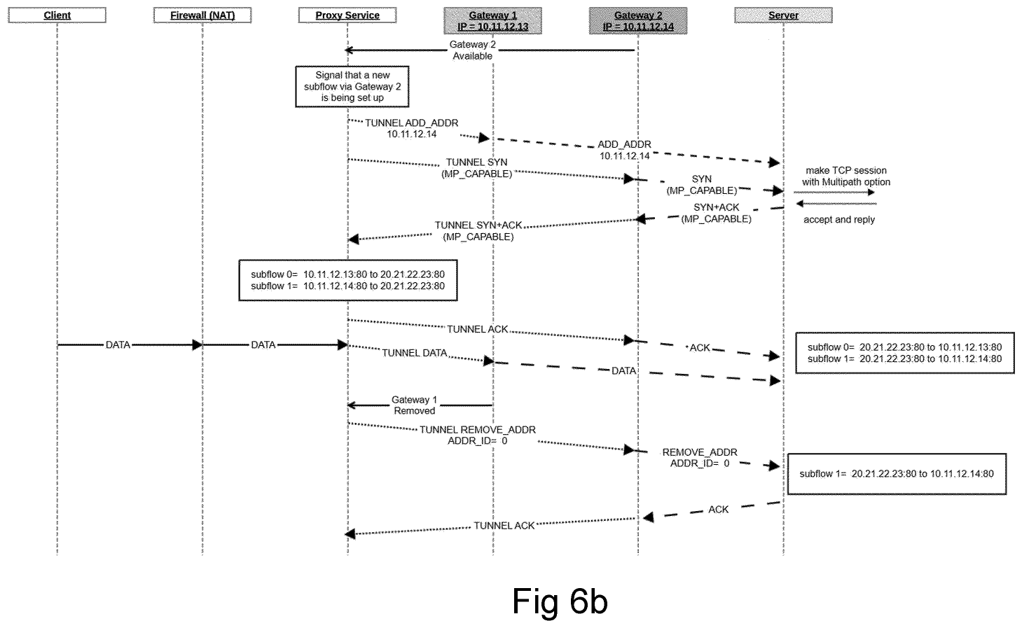

In connection with FIGS. 6a-6b, the sequence of the data, including messages, requests, responses, and acknowledgements, among the equipment 1, the user devices 3, 4, 5, 7, and the server 2 will be discussed in more detail.

The server 2 of this example may be a Cloud endpoint that understands and accept Multipath TCP, which allows a TCP connection to use multiple paths to maximize resource usage and increase redundancy.

The equipment 1 of this example comprises a service CLIENT, running on the equipment 1. The CLIENT is configured to request a connection to the server 2.

The equipment 1 of this example comprises a firewall module FIREWALL, which is configured to implement Network Address Translation (NAT).

In this example, there are two user devices, GATEWAY1 and GATEWAY 2, each having an application, i.e. APP1 and APP2, installed and run on it. The APP1 and APP2 are configured to forward the received data to the destination of the data, i.e. to the server 2 or the equipment 1.

The equipment 1 of this example comprises a service PROXY, running on the equipment 1. The PROXY is configured to intercept network traffic coming from the FIREWALL and forward it to the App1 of the GATEWAY1 and/or the App2 of the GATEWAY2.

The PROXY may create a virtual network interface for each of the GATEWAY1 and GATEWAY2. A virtual communication channel between the PROXY and the APP1 and APP2 running on the GATEWAY1 and GATEWAY2 is a “tunnel”.

The IP addresses of the GATEWAY1, GATEWAY2, and the server 2 are 10.11.12.13 on port 80, 10.11.12.14 on port 80, and 20.21.22.23 on port 80, respectively.

In connection with the following steps of the example of FIG. 6a, the data transferring among a first user device of the at least two user devices, the equipment, and the server, will be discussed in more detail.

Step 601. The GATEWAY1 connects to the equipment 1.

The GATEWAY1 may have become available for connecting to the equipment 1. For example, a user 1 carrying the GATEWAY1 may move and stay in close proximity to the equipment 1.

The GATEWAY1 and/or the equipment 1 may be authenticated before establishing the first wireless communication channel. An identity of the GATEWAY1 may be compared with identities of a first trust list. An identity of the equipment 1 may be compared with identities of a second trust list. The first and second trust list may be the same or different trust lists.

The authentication may improve the security of the data transferring, such that the data transferring can only be made between and can only pass through the authenticated devices.

The identity of the user device may be a unique Media Access Control address (MAC address).

The first trust list may comprise the identities of a restricted group of the user devices. For example, the identities of the user devices of the employees may be added in the first trust list. Consequently, a user device of a visitor cannot pass the authentication for connecting to the equipment 1.

The first and second trust lists may be maintained and stored blockchain technology.

Step 602. The APP1 of GATEWAY1 connects to the PROXY of the equipment 1.

Step 603. The CLIENT initiates a TCP session towards the server 2 by sending an initial request (SYN) to the IP address of the server 2 (20.21.22.23 on port 80) via the FIREWALL.

Step 604. The FIREWALL intercepts the initial request and forwards the intercepted TCP segments towards the PROXY.

Step 605. The PROXY negotiates a TUNNEL1 with the APP1 of the GATEWAY1.

Step 606. The PROXY modifies the TCP header of the intercepted TCP segments.

The TCP header may be modified to include information in the fields of the TCP header. The information may be a first TOKEN (e.g., 1234). The information may comprise a key word (e.g., MP_CAPABLE) for indicating the use of multipath TCP.

Step 607. The PROXY sends the modified initial request (SYN) over the TUNNEL1 towards the APP1 of the GATEWAY1.

Step 608. The APP1 of the GATEWAY1 forwards the modified initial request (SYN) towards the server 2.

Step 609. The server 2 accepts the connection, initiates a TCP session by sending an initial response (SYN+ACK).

The TCP header of the initial response (SYN+ACK) may comprise information. The information may be a second TOKEN (e.g., 3456). The information may comprise the key word (e.g., MP_CAPABLE) for indicating that the server 2 can accept multipath TCP.

Step 610. The APP1 of the GATEWAY1 forwards the initial response (SYN+ACK) to the PROXY.

This may be an indication that a communication session SUBFLOW 0 from the GATEWAY1 (10.11.12.13:80) to the server 2 (20.21.22.23:80) is created.

A communication session may be a temporary and interactive information interchange between two or more communicating devices. A communication session may be established at a certain point in time, and be ended at a later point.

Step 611. The PROXY modifies the TCP header of the initial response (SYN+ACK).

The key word (e.g., MP_CAPABLE) of the TCP header may be removed.

Step 612. The PROXY sends the modified initial response (SYN+ACK) to the CLIENT via the FIREWALL.

Step 613. The CLIENT replies with an acknowledgement (ACK) to the PROXY via the FIREWALL.

Step 614. The PROXY modifies the TCP header of the acknowledgement (ACK).

Step 615. The PROXY sends the modified acknowledgement (ACK) via the TUNNEL1 to the APP1 of the GATEWAY1.

Step 616. The APP1 of the GATEWAY1 forwards the modified acknowledgement (ACK) to the server 2.

Step 617. After receiving the modified acknowledgement (ACK), the server 2 determines that a communication session SUBFLOW0 from the server 2 (20.21.22.23:80) to the GATEWAY1 (10.11.12.13:80) exists.

In other words, a first bidirectional communication session SUBFLOW0 between the equipment 1 and the server 2 (20.21.22.23:80) via the GATEWAY1 (10.11.12.13:80) is established.

Step 618. The CLIENT sends a data packet (DATA) to the server 2 via the APP1 of the GATEWAY1.

Step 619. The PROXY modifies the TCP header of the data packet (DATA) such that the data packet (DATA) will be sent to the server 2 by using the SUBFLOW0.

Step 620. The PROXY sends the modified data packet (DATA) through the TUNNEL1 via the APP1 of the GATEWAY1.

Step 621. The APP1 of the GATEWAY1 forwards the modified data packet (DATA) to the server 2 by using the SUBFLOW0.

The server 2 may reply with an acknowledgement response (ACK) to the CLIENT via the APP1 of the GATEWAY1 by using the SUBFLOW0.

The data packet (DATA) of the example of FIG. 6a may be a part of a log file.

Analogously, the CLIENT may request to download a data packet (e.g., a firmware) from the server 2 via the APP1 of the GATEWAY1.

In connection with the example of FIG. 6b, a multipath communication using two user devices will be discussed in more detail. The time periods of the GATEWAY1 and the GATEWAY2 respectively transferring data are partially overlapping in this example.

In the example of FIG. 6b, the first bidirectional communication session SUBFLOW0 via the GATEWAY1 (10.11.12.13:80) is already established as shown in FIG. 6a.

The GATEWAY2 may connect to the equipment 1.

The GATEWAY2 may have become available for connecting to the equipment 1. For example, a user 2 carrying the GATEWAY2 may move and stay in close proximity to the equipment 1.

The APP2 of the GATEWAY2 may connect to the PROXY of the equipment 1.

The PROXY may inform the server 2 that a new IP address, i.e. the IP address of the GATEWAY2 (10.11.12.14 on port 80), is available, by sending a message (ADD_ADDR) over the SUBFLOW0 via the GATEWAY1.

The PROXY may negotiate a TUNNEL2 with the APP2 of the GATEWAY2.

The PROXY may initialize a TCP session towards the server 2 by sending an initial request (SYN) to the IP address of the server 2 (20.21.22.23 on port 80), through the TUNNEL2 via the APP2 of the GATEWAY 2.

The TCP header of the initial request (SYN) may comprise a token exactly the same as the first TOKEN (e.g., 1234) used in step 606.

The TCP header may comprise the key word (e.g., MP_CAPABLE) for indicating the use of multipath TCP.

After receiving the initial request (SYN), the server 2 may initiate a TCP session towards the GATEWAY2 related to the existing session as indicated by the TOKEN of the initial request (SYN).

After a similar three-way handshake as of steps 607-610, the PROXY may determine that a new SUBFLOW1 from the GATEWAY2 (10.11.12.14:80) to the server 2 (20.21.22.23:80) is created.

After a similar three-way handshake as of steps 615-617, the server may determine that a communication session SUBFLOW1 from the server 2 (20.21.22.23:80) to the GATEWAY2 (10.11.12.14:80) exists.

In other words, a second bidirectional communication session SUBFLOW1 between the equipment 1 and the server 2 (20.21.22.23:80) via the GATEWAY2 (10.11.12.14:80) is established.

The CLIENT may send a data packet (DATA) to the server 2. The PROXY may modify the TCP header of the data packet (DATA) such that the data packet (DATA) will be sent to the server 2 by using both the SUBFLOW0 and the SUBFLOW1.

The PROXY may send the modified data packet (DATA) through both the TUNNEL1 via the APP1 of the GATEWAY1, and the TUNNEL2 via the APP2 of the GATEWAY2.

The APP1 of the GATEWAY1 and the APP2 of the GATEWAY2 may respectively forward the modified data packet (DATA) to the server 2 using the SUBFLOW0 and SUBFLOW1.

The data forwarding by the APP1 of the GATEWAY1 and the APP2 of the GATEWAY2 may be the same or different.

The TCP congestion control may be used to optimize a sum of throughputs of the SUBFLOW0 and SUBFLOW1.

The GATEWAY1 may be disconnected from the equipment 1.

The GATEWAY1 may have become unavailable for connecting to the equipment 1. For example, the user 1 carrying the GATEWAY1 may move away and no longer being in close proximity to the equipment 1.

The PROXY may send a request (REMOVE_ADDRESS) to the server 2 over the TUNNEL2 via the GATEWAY2 to terminate the SUBFLOW0.

The server 2 may reply with an acknowledgement (ACK) for acknowledging that the SUBFLOW0 is terminated.

Since the SUBFLOW1 is still existed, even though the GATEWAY1 is disconnected from the equipment 1 (i.e. the SUBFLOW0 is terminated), the data transferring between the equipment 1 and the server 2 is uninterrupted from the equipment's point of view.

Analogously, one or more user devices can be added or removed without influencing the flows of the communication session between the equipment 1 and the server 2 via other user devices.

The CLIENT may terminate the connection with the APP2 of the GATEWAY2, when the data transferring between the equipment 1 and the server 2 is completed, e.g., when the firmware has been completed downloaded.

The CLIENT may terminate the connection with the APP2 when the GATEWAY2 is disconnected from the equipment 1.

The PROXY may terminate the TUNNEL2 between the APP2 of the GATEWAY2 and the equipment 1.

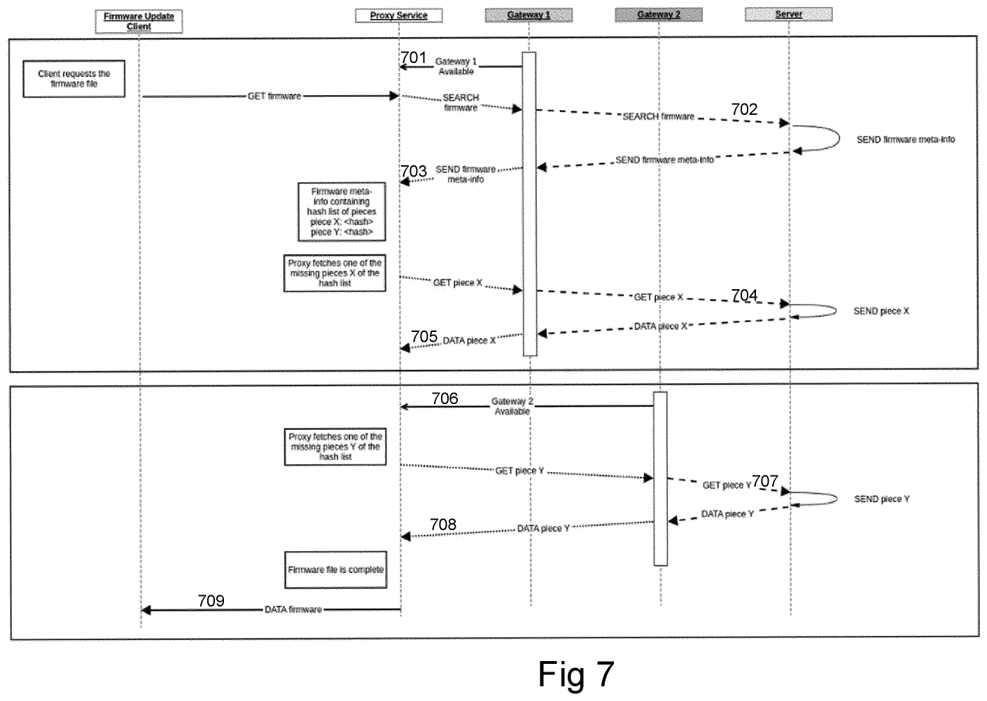

In connection with the example of FIG. 7, a first and a second indirect wireless communications using each of two user devices will be discussed in more detail.

The system of this example may be a peer-to-peer (P2P) system.

The term P2P may refer to a decentralised distributed architecture comprising a plurality of peers, each peer making a portion of its resource available to other peers. Peers may be both supplier and consumers of the resources. The P2P is different from the traditional client-server model, wherein the server provides the resources and the client consumes the resources. In the P2P protocols, the clients both provide and consume resources.

In this example, the BitTorrent protocol is used as an example. However, any other types of P2P protocols may be used.

The equipment 1 of this example comprises a service CLIENT, running on the equipment 1. The CLIENT is configured to request to download a firmware.

The equipment 1 of this example comprises a firewall module FIREWALL, similar to the examples of FIGS. 6a-6b.

In this example, there are two user devices, GATEWAY1 and GATEWAY 2, similar to the examples of FIGS. 6a-6b. Each of the user devices GATEWAY1 and GATEWAY 2 may have an APP installed for controlling the data transferring through them, in a way similar to the previous examples. Thus, the APP is not discussed in detail in the following example.

The equipment 1 of this example comprises a service PROXY, running on the equipment 1, similar to the examples of FIGS. 6a-6b.

In connection with the following steps of the example of FIG. 7, the first and the second indirect wireless communications using each of two user devices will be discussed in more detail.

Step 701. The GATEWAY1 connects to the equipment 1.

The GATEWAY1 may have become available for connecting to the equipment 1.

The first indirect wireless communications between the equipment 1 and the server 2 via the GATEWAY1 may be established.

Step 702. The CLIENT requests to download a firmware from the server 2 via the PROXY. The request is forward to the server 2 via the GATEWAY1.

The Proxy may be responsible for downloading the complete firmware.

Step 703. The server 2 replies with a firmware meta information to the PROXY via the GATEWAY1.

The meta information may be a torrent file of the BitTorrent protocol.

The meta information may comprise a list of hashes for each piece of the firmware being split into.

For example, if the firmware is split into two parts, i.e. a first part X and a second part Y. The firmware meta information may comprise a list of a first harsh and a second harsh corresponding to the first part X and the second part Y, respectively.

Step 704. The PROXY requests to download a first available part of the firmware.

There is no requirement for fetching the different parts of the data in any particular order.

In this example, the first part X of the firmware is available for downloading. The PROXY may request to download the first part X of the firmware from the server 2 via the GATEWAY1.

Step 705. The server 2 replies with the first part X of the firmware to the PROXY via the GATEWAY1.

The PROXY may verify the integrity of the downloaded part using the known hashes of the meta information.

If the hash of the downloaded part matches the hash of the meta information, it is determined that the first part X of the firmware has been completely downloaded. The PROXY may request to download a next missing part of the firmware.

If the hash of the downloaded part does not match the hash of the meta information, it is determined that the first part X of the firmware has not been completely downloaded. The PROXY may request to continue downloading the first part X of the firmware.

The GATEWAY1 may be disconnected from the equipment 1. The GATEWAY1 may have become unavailable for connecting to the equipment 1.

The firmware downloading via the GATEWAY1 may be interrupted.

Step 706. The GATEWAY2 connects to the equipment 1. The GATEWAY2 may have become available for connecting to the equipment 1.

The second indirect wireless communications between the equipment 1 and the server 2 via the GATEWAY2 may be established.

Step 707. The PROXY requests to download the next missing part of the firmware.

In this example, since the PROXY has completely downloaded the first part X of the firmware from the server 2 via the GATEWAY1, the next missing part of the firmware is the second part Y.

If the first part X was not completely downloaded, the PROXY may request to continue downloading the first part X.

Step 708. The server 2 replies with the second part Y of the firmware to the PROXY via the GATEWAY2.

The PROXY may verify the integrity of the downloaded part using the known hashes of the meta information.

If the hash of the downloaded part matches the hash of the meta information, it is determined that the second part Y of the firmware has been completely downloaded. The PROXY may request to download a next missing part of the firmware, if there is any.

If the hash of the downloaded part does not match the hash of the meta information, it is determined that the second part Y of the firmware has not been completely downloaded. The PROXY may request to continue downloading the second part Y of the firmware.

Step 709. The PROXY forwards the complete firmware to the CLIENT.

After the different parts of the firmware have been completely downloaded, the firmware file may be reconstructed based on the downloaded different parts.

The equipment 1 may performing a firmware update using the downloaded firmware.

In the example of FIG. 7, the time periods of the GATEWAY1 and the GATEWAY2 respectively transferring data are nonoverlapping. The data downloaded by the GATEWAY1 and the GATEWAY2 are different parts of the same firmware.

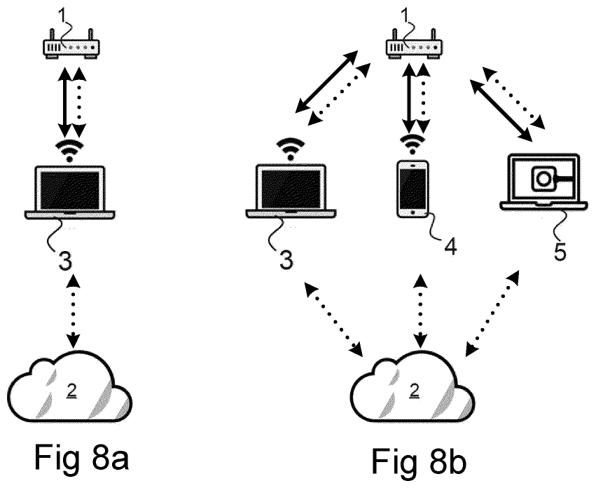

In connection with FIGS. 8a-8b, the system of transferring data between the server and the equipment will be discussed in more detail.

In FIG. 8a, only one user device 3 is provided. In FIG. 8b, three user devices 3, 4, 5 are provided. One or more user devices may be used.

The equipment 1, the server 2, the user devices 3, 4, 5 are the same as those in the previous examples. The features of the previous examples are also applicable to the following examples, which will not be discussed in detail.

The at least one user device 3, 4, 5 is configured to transfer a first data with the equipment 1 by using a first wireless communication channel between the equipment 1 and the at least one user device 3, 4, 5.

The user device is configured to establish a second communication channel for transferring data with the server 2.

The second data is transferred between the equipment 1 and the server 2 via the at least one user device 3, 4, 5, by using the first wireless communication channel and the second communication channel, based on the estimated capacity of the first wireless communication channel for transferring the second data between the equipment 1 and the at least one user device 3, 4, 5 is estimated.

In FIGS. 8a-8b, the transfer of the first data is represented by the solid lines with arrows between the equipment 1 and the at least one user device 3, 4, 5. The transfer of the second data is represented by the dotted lines with arrows between the equipment 1 and the at least one user device 3, 4, 5, and between the server 2 and the at least one user device 3, 4, 5.

The second data may comprise any of a firmware, a log file, usage metrics, a software package, a data stream, a remote management message, and a digital signage.

The system may comprise a channel control module (not shown) configured to estimate the capacity of the first wireless communication channel for transferring the second data between the equipment 1 and the at least one user device 3, 4, 5.

The channel control module may be deployed in a device, e.g., any of the at least one user device 3, 4, 5, the equipment 1, the server 2, and any other devices.

Functions and operations of the channel control module may be embodied in the form of executable logic routines (e.g., lines of code, software programs, etc.) that are stored on a non-transitory computer readable medium (e.g., the memory) of said device, and are executed by a processing circuit of said device.

The executable logic routines may be in the form of an application (APP). The APP may be stored in the memory of said device.

The functions and operations of the channel control module may be a stand-alone software application or form a part of a software application that carries out additional tasks related to said device. The described functions and operations may be considered a method that said device is configured to carry out. Also, while the described functions and operations may be implemented in software, such functionality may as well be carried out via dedicated hardware or firmware, or some combination of hardware, firmware and/or software.

The channel control module may be configured to configure the first wireless communication channel based on the estimated capacity for transferring the second data.

For example, the channel control module may configure any property of the first wireless communication channel, including but not limited to a data transfer rate, a size, a type, a duplication, a priority of commands and data or data packet.

The channel control module may be configured to modulate a command for sending and/or receiving the second data.

The channel control module may be configured to start and/or terminate transferring of the second data.

The secondly data may be transferred between the equipment 1 and the server 2 via a single user device 3, as shown in FIG. 8a.

Alternatively, the secondly data may be transferred between the equipment 1 and the server 2 via a plurality of user devices 3, 4, 5, as shown in FIG. 8b.

When there are at least two user devices, as shown in FIG. 8b, the channel control module may configure more than one first wireless communication channel to transfer the second data.

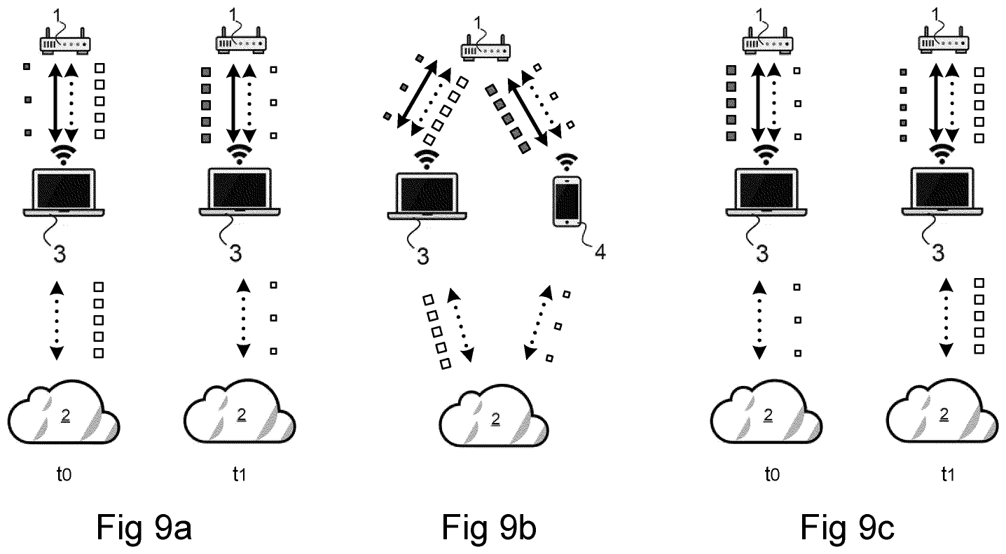

In connection with FIGS. 9a-9c, the method of transferring data between the server and the equipment will be discussed in more detail.

The method comprises the at least one user device 3, 4, 5 establishing a second communication channel for transferring data with the server 2. The second communication channel may be a wired channel or wireless.

The method comprises estimating a capacity of the first wireless communication channel for transferring the second data between the equipment 1 and the at least one user device 3, 4, 5.

The method comprises transferring the second data between the equipment 1 and the server 2 via the at least one user device 3, 4, 5, by using the first wireless communication channel and the second communication channel, based on the estimated capacity.

Thus, the second data may be “piggybacked” on the existing first wireless connection(s) between the equipment 1 and one or more user devices 3, 4, 5, to enable a wireless data transfer functionality for the equipment 1 which cannot establish a direct wireless communication with the server. In other words, besides the data that the existing wireless connection(s) is allocated for transferring, additional data is also transferred by using the existing wireless connection(s).

The term “piggyback” in the application may refer to using the existing first wireless communication channel for transferring the second data, which the first wireless communication channel is not originally allocated for.

Transferring the second data by using the existing first wireless communication channel may be “transparent” to a user using the first wireless communication channel for transferring the first data.

The term “transparent” may refer to that the user device and/or the user using the first wireless communication channel would not notice any changes to the transfer of the first data or to the first wireless communication channel, caused by the transfer of the second data.

The term “transparent” may refer to that any changes to the data transfer of the first data and/or to the first wireless communication channel, caused by the transfer of the second data, would not exceed an allowable limit, such that the impact to the data transfer of the first data and/or to the first wireless communication channel would be minimised, or at least be controllable.

The capacity of the first wireless communication channel may comprise any of: a bandwidth, a throughput, a latency, a bit-error rate, BER, and a packet-error rate, PER, of the first wireless communication channel.

The step of estimating a capacity of the first wireless communication channel for transferring the second data between the equipment 1 and the at least one user device 3, 4, 5 may comprise:
estimating the capacity of the first wireless communication channel for transferring the second data between the equipment 1 and the at least one user device (3, 4, 5) based on any of:
a property of the first wireless communication channel; and
a requirement of transfer of the second data.

The property of the first wireless communication channel may be static or dynamic.

The requirement of transfer of the second data may be static or dynamic.

The property of the first wireless communication channel may comprise a physical property of the first wireless communication channel, such as a type of the channel and a physical connection of the channel.

The type of the first wireless communication channel may be, e.g., a simplex channel, a multiplexed channel, an upstream channel, a downstream channel, a broadcast channel, etc.

The property of the first wireless communication channel may comprise a usage information of the first wireless communication representing a usage of the first wireless communication channel for transferring the first data. Based on the usage of the first wireless communication channel for transferring the first data, the capacity of the first wireless communication channel that can be used to transfer the second data may be estimated.

The usage information may be a current usage of the first wireless communication for transferring the first data, or an estimated usage of the first wireless communication for transferring the first data in a future time point. It is advantageous to estimate the capacity of the first wireless communication channel that can be used to transfer the second data in a future time point, as it may facilitate the planning of the resources (e.g., the user devices) in advance.

The estimated usage may be generated based on information about a user pattern. For example, when the user pattern indicates that a large number of first data transfer between the equipment and the user device is going to happen, the estimated usage may be used to prevent too much capacity of the first wireless communication channel being used for transferring the second data.

In FIGS. 9a-9c, the transfer of the first data is represented by the solid lines with arrows between the equipment 1 and the at least one user device 3, 4. The filled blocks besides the solid lines with arrows are added for representing the usage of the first wireless communication channel for transferring the first data.

The transfer of the second data is represented by the dotted lines with arrows between the equipment 1 and the at least one user device 3, 4, and between the server 2 and the at least one user device 3, 4. The non-filled blocks besides the dotted lines with arrows are added for representing the usage of the first wireless communication channel for transferring the second data, and the usage of the second communication channel for transferring the second data.

In FIGS. 9a-9c, the blocks of different sizes, of different numbers, and having different spacings, are merely used to symbolise the different usages (e.g., a high usage and a low usage) of the first wireless communication channel for transferring the first data and for transferring the second data, respectively.

Examples of the usage of a channel may comprise any of: a usage of a bandwidth, a usage of a throughput, a number of transferred data/data packets per time unit, etc., of the channel.

A high usage of a channel may be a usage higher than 50% of a capacity (e.g., a bandwidth) of the channel. A low usage of a channel may be a usage lower than 50% of the channel.

The left part of FIG. 9a shows the different usages of the first wireless communication channel for transferring the first and the second data at a time point t₀.

In the left part of FIG. 9a, at the time point t₀, the transfer of the first data has a low usage of the first wireless communication channel, represented by the three filled, small and spaced blocks. The estimated capacity of the first wireless communication channel for transferring the second data may be high. Based on the estimated capacity, the transfer of the second data may have a high usage of the first wireless communication channel, represented by the five non-filled, large and less-spaced blocks.

The right part of FIG. 9a shows the different usages of the first wireless communication channel for transferring the first and the second data at a time t₁, which is a time point after the time point t₀.

In the right part of FIG. 9a, at the time point t₁, the transfer of the first data has a high usage of the first wireless communication channel, represented by the five filled, large and less-spaced blocks. The estimated capacity of the first wireless communication channel for transferring the second data may be low. Based on the estimated capacity, the transfer of the second data may have a low usage of the first wireless communication channel, represented by the three non-filled, small and spaced blocks.

As shown in the example of FIG. 9a, the property of the first wireless communication channel may be dynamic over time. The property information of the first wireless communication channel may be determined based on a current channel performance measure. For example, the bandwidth of the first wireless communication channel may be 100 Mbit/s and the current usage of the first wireless communication channel for transferring the first data is only 10 Mbit/s. Then, the first wireless communication channel may be able to provide a bandwidth up to 90 Mbit/s for transferring the second data.

In other words, the estimated capacity of the first wireless communication channel for transferring the second data between the equipment 1 and the at least one user device 3, 4, 5 may be dynamic. Thus, the invention may provide an improved flexibility, and a reduced waste of resource.

Alternatively, the property of the first wireless communication channel may be static. For example, the property may be a bandwidth. The bandwidth of the first wireless communication channel may be 100 Mbit/s and the usage of the first wireless communication channel for transferring the first data may be pre-determined to be 80 Mbit/s. Then, the first wireless communication may be able to provide a bandwidth up to 20 Mbit/s for transferring the second data, irrespective of the actual bandwidth for transferring the first data.

The requirement of transfer of the second data may be static. For example, the requirement may be pre-determined to be 10 Mbit/s for transferring the second data.

The requirement of transfer of the second data may be dynamic. For example, the requirement may be dynamically determined based on content of the second data.

The requirement of transfer of the second data may comprise information related to the second data, such as the content of the second data, the size of the second data, the priority of the second data, etc.

In connection with FIG. 9b, the method involving at least a first user device 3 and a second user device 4 will be discuss in more detail.

In FIG. 9b, the first user device 3 is capable of transferring data with the equipment 1 by using the wireless communication channel between the equipment 1 and the first user device 3.

The second user device 4 is capable of transferring data with the equipment 1 by using the wireless communication channel between the equipment 1 and the second user device 4.

The step of estimating a capacity of the first wireless communication channel for transferring the second data between the equipment 1 and the at least one user device 3, 4, 5 may comprise: estimating a first capacity of the wireless communication channel for transferring the second data between the equipment 1 and the first user device 3; and estimating a second capacity of the wireless communication channel for transferring the second data between the equipment 1 and the second user device 4.

In FIG. 9b, the transfer of the first data via the first user device 3 has a low usage of its first wireless communication channel, represented by the three filled, small and spaced blocks. The estimated capacity of said first wireless communication channel for transferring the second data may be high. Based on the estimated capacity, the transfer of the second data may have a high usage of said first wireless communication channel, represented by the five non-filled, large and less-spaced blocks.

In FIG. 9b, the transfer of the first data via the second user device 4 has a high usage of its first wireless communication channel, represented by the five filled, large and less-spaced blocks. The estimated capacity of said first wireless communication channel for transferring the second data may be low. Based on the estimated capacity, the transfer of the second data may have a low usage of said first wireless communication channel, represented by the three non-filled, small and spaced blocks.

The step of transferring the second data between the equipment 1 and the server 2 via the at least one user device 3, 4, 5 may comprise: transferring a first part of the second data between the equipment 1 and the server 2 via the first user device 3, based on the first estimated capacity; and transferring a second part of the second data between the equipment 1 and the server 2 via the second user device 4, based on the second estimated capacity.

The first and second part of the second data may be a same part of the second data, or different parts of the second data.

Both the first and second user device 3, 4 may be used to transfer the same part of the second data to improve the robustness of the transfer of the second data.

The first and second user device 3, 4 may be used to transfer different parts of the second data to increase the transfer speed of the second data.

In connection with FIG. 9c, the priority of transfer of the first and second data will be discussed in more detail.

The method may comprise when a priority of transfer of the second data is high, or when a priority of transfer of the second data is higher than a priority of transfer of the first data, prioritising transfer of the second data over the transfer of the first data.

The left part of FIG. 9c shows the different usages of the first wireless communication channel for transferring the first and the second data at a time point t₀, when a priority of transfer of the second data is low, or when a priority of transfer of the second data is lower than a priority of transfer of the first data.

In the left part of FIG. 9c, at the time point t₀, the transfer of the first data has a high usage of the first wireless communication channel, represented by the five filled, large and less-spaced blocks. The estimated capacity of the first wireless communication channel for transferring the second data may be low. Based on the estimated capacity, the transfer of the second data may have a low usage of the first wireless communication channel, represented by the three non-filled, small and spaced blocks.

The right part of FIG. 9c shows the different usages of the first wireless communication channel for transferring the first and the second data at a time point t₁, when a priority of transfer of the second data is high, or when a priority of transfer of the second data is higher than a priority of transfer of the first data.

In the right part of FIG. 9a, at the time point t₁, the usage of the first wireless communication channel for transferring the first data has been reduced, represented by the five filled, small and spaced blocks, in order to prioritise the transfer of the second data. Consequently, the usage of the first wireless communication channel for transferring the second data may be increased, represented by the five non-filled, large and less-spaced blocks.

The method may comprise sending, a request to the at least one user device 3, 4, 5 for changing the transfer of the first data for prioritising the transfer of the second data.

For example, when the second data comprises an urgent firmware update for upgrading the equipment, the transfer of the second data may be prioritised. A request may be sent to the at least one user device 3, 4, 5 for changing the transfer of the first data. For example, the bandwidth used for transferring the first data may be temporally reduced, and the bandwidth used for transferring the second data may be temporally increased.

The person skilled in the art realizes that the present invention by no means is limited to the examples described above. On the contrary, many modifications and variations are possible within the scope of the appended claims. For example, the transferred data may be in different formats, and the first communication channel may be of different types of wireless communication. Such details are not considered to be an important part of the invention, which relates to the method of transferring data between a server and an equipment which cannot establish a direct wireless communication with the server.

1-33. (canceled)

34. A method of transferring data between a server and an equipment which cannot establish a direct wireless communication with the server, the method comprising:
at least two user devices, each establishing a first wireless communication channel with the equipment via a first wireless communication interface of said user device;
each of the at least two user devices establishing a second communication channel for connecting to the server via a second communication interface of said user device;
establishing an indirect wireless communication between the equipment and the server, via the at least two user devices, by using the first wireless communication channel and the second communication channel of any of the at least two user devices;
transferring data between the equipment and the server through the established indirect wireless communication;
wherein a first and a second part of the data are transferred between the equipment and the server via a first and a second user device of the at least two user devices, respectively;
wherein the first and second part of the data are a same part of the data, or different parts of the data;
wherein the data may comprise any of a firmware, a log file, usage metrics, a software package, a data stream, a remote management message, a digital signage;
wherein the first wireless communication channel is established only when said user device is within a predetermined distance from the equipment.

35. The method of claim 34, wherein transferring data between the equipment and the server comprises:
uploading the data from the equipment to the server, and/or downloading the data from the server to the equipment.

36. The method of claim 34, wherein a first time period for transferring the first part of the data and a second time period for transferring the second part of the data are at least partially overlapping, or are nonoverlapping.

37. The method of claim 35, wherein the downloaded data comprises a firmware of the equipment;
the method further comprising:
the equipment performing a firmware update using the downloaded data.

38. The method of claim 35,
wherein uploading the data from the equipment to the server comprises:
the equipment requesting the at least two user devices to upload the data to the server;
each of the at least two user devices connecting to the server through the second communication channel;
the equipment uploading the data to each of the at least two user devices through the first wireless communication channel;
each of the at least two user devices uploading the data to the server through the second communication channel; and
wherein downloading the data from the server to the equipment comprises:
the equipment requesting the at least two user devices to download the data from the server;
each of the at least two user devices connecting to the server through the second communication channel;
each of the at least two user devices downloading the data from the server through the second communication channel;
the equipment downloading the data from each of the at least two user devices through the first wireless communication channel.

39. The method of claim 38,
wherein uploading the data from the equipment to the server comprises:
the server sending a response to the at least two user devices-indicating whether the uploading is successful or not;
preferably, the at least two user devices forwarding the response to the equipment; and
wherein downloading the data from the server to the equipment comprises:
the equipment sending a response to the at least two user devices indicating whether the downloading is successful or not,
preferably, the at least two user devices forwarding the response to the server.

40. The method of claim 34, comprising:
a proxy of the equipment creating a virtual network interface for each of the at least two user devices.

41. The method of claim 40, comprising:
the first user device establishing its first wireless communication channel with the proxy;
the first user device establishing its second communication channel connecting to the server;
establishing a first indirect wireless communication for transferring the data between the equipment and the server via the first user device, by using the first wireless communication channel and the second communication channel established by the first user device;
transferring the first part of the data between the equipment and the server through the first indirect wireless communication;
the second user device establishing its first wireless communication channel with the proxy;
the second user device establishing its second communication channel connecting to the server;
establishing a second indirect wireless communication for transferring the data between the equipment and the server via the second user device, by using the first wireless communication channel and the second communication channel established by the second user device;
transferring the second part of the data between the equipment and the server through the second indirect wireless communication.

42. The method of claim 41, comprising:
the first user device establishing its first wireless communication channel with the proxy;
the first user device establishing its second communication channel connecting to the server;
establishing a communication session comprising a first flow for transferring the data between the equipment and the server via the first user device, by using the first wireless communication channel and the second communication channel established by the first user device;
the second user device establishing its first wireless communication channel with the proxy;
the second user device establishing its second communication channel connecting to the server;
establishing a second flow for transferring the data between the equipment and the server via the second user device, by using the first wireless communication channel and the second communication channel established by the second user device;
adding the second flow to the communication session;
transferring the data between the equipment and the server by using both the first and second flow of the established communication session.

43. The method of claim 42, comprising:
the proxy establishing a first tunnel between the proxy and the first user device by negotiating with the first user device;
the equipment sending an initial request (SYN) to the first user device via the proxy through the first tunnel for initiating the first flow of the communication session towards the server;
the first user device forwarding the initial request (SYN) to the server through its second communication channel;
the server receiving the initial request (SYN), and sending an initial response (SYN+ACK) to the first user device through the second communication channel of the first user device, for indicating acceptance of the first flow of the connection session initiated by the equipment and for initiating the first flow of the communication session towards the equipment;
the first user device forwarding the initial response (SYN+ACK) to the proxy;
after receiving the initial response (SYN+ACK), the equipment sending an acknowledgement (ACK) to the first user device via the proxy through the first tunnel for indicating acceptance of the first flow of the connection session initiated by the server;
the first user device forwarding the acknowledgement (ACK) to the server through its second communication channel;
wherein after the server receives the acknowledgement (ACK), the communication session comprising the first flow for transferring the data between the equipment and the server via the first user device, by using the first wireless communication channel and the second communication channel established by the first user device, is established.

44. The method of claim 43, further comprising:
the equipment sending a first data (DATA) to the first user device via the proxy through the first tunnel; and
the first user device forwarding the first data (DATA) to the server through its second communication channel;
after receiving the first data (DATA), the server sending a response to the first user device indicating whether the first data is successful received or not;
preferably, the first user device forwarding the response to the equipment.

45. The method of claim 43, further comprising:
the server sending a second data through the second communication channel of the first user device to the first user device; and
the first user device forwarding the second data to the equipment via the proxy through the first tunnel;
after receiving the second data, the equipment sending a response to the first user device indicating whether the second data packet is successful received or not;
preferably, the first user device forwarding the response to the server.

46. The method of claim 42, further comprising:
after the second user device establishing its first wireless communication channel with the proxy, the proxy sending a first message (ADD_ADDR) to the server via the first user device through the first tunnel, for informing the existence of the second user device;
the proxy establishing a second tunnel between the proxy and the second user device by negotiating with the second user device;
the proxy sending an initial request (SYN) to the second user device through the second tunnel for initiating the second flow of the communication session towards the server;
the second user device forwarding the initial request (SYN) to the server via its second communication channel;
the server receiving the initial request (SYN), and sending an initial response (SYN+ACK) to the second user device through the second communication channel of the second user device, for indicating acceptance of the second flow of the connection session initiated by the equipment and for initiating the second flow of the communication session towards the equipment;
the second user device forwarding the initial response (SYN+ACK) to the proxy;
after receiving the initial response (SYN+ACK), the proxy sending an acknowledgement (ACK) to the second user device through the second tunnel for indicating acceptance of the second flow of the connection session initiated by the server;
the second user device forwarding the acknowledgement (ACK) to the server through its second communication channel;
wherein after the server receives the acknowledgement (ACK), the second flow for transferring the data between the equipment and the server via the second user device, by using the first wireless communication channel and the second communication channel established by the second user device is established.

47. The method of claim 42, comprising:
when the established first wireless communication channel of the first user device is interrupted or terminated,
terminating the first flow of the established communication session.

48. The method of claim 47, wherein terminating the first flow comprises:
the proxy sending a second message (REMOVE_ADDR) to the server to terminating the first flow, via the second user device through the second tunnel.

49. The method of claim 34, comprising:
authenticating the at least two user devices before establishing the first wireless communication channel, comprising:
comparing an identity of the at least two user devices with identities of a first trust list;
and/or
authenticating the equipment before establishing the first wireless communication channel, comprising:
comparing an identity of the equipment with identities of a second trust list;
wherein the first and second trust list is the same or different trust lists.

50. A system of transferring data between a server and an equipment which cannot establish a direct wireless communication with the server, the system comprising:
the equipment,
the server, and
at least two user devices,
wherein each of the at least two user devices is configured to
establish a first wireless communication channel with the equipment via a first wireless communication interface of said user device;
establish a second communication channel for connecting to the server via a second communication interface of said user device; wherein an indirect wireless communication between the equipment and the server is established, via the at least two user devices, by using the first wireless communication channel and the second communication channel of any of the at least two user devices, for transferring data between the equipment and the server;
wherein a first and a second part of the data are transferred between the equipment and the server via a first and a second user device of the at least two user devices, respectively;
wherein the first and second part of the data are a same part of the data, or different parts of the data;
wherein the data may comprise any of a firmware, a log file, usage metrics, a software package, a data stream, a remote management message, a digital signage;
wherein the first wireless communication channel is established only when said user device is within a predetermined distance from the equipment.

51. A method of transferring data between a server and an equipment which cannot establish a direct wireless communication with the server,
wherein at least one user device is capable of transferring a first data with the equipment by using a first wireless communication channel between the equipment and the at least one user device,
the method comprising:
the at least one user device establishing a second communication channel for transferring data with the server;
estimating a capacity of the first wireless communication channel for transferring the second data between the equipment and the at least one user device; and
based on the estimated capacity, transferring the second data between the equipment and the server via the at least one user device, by using the first wireless communication channel and the second communication channel, based on the estimated capacity.

52. The method of claim 51, wherein the capacity of the first wireless communication channel comprises any of: a bandwidth, a throughput, a latency, a bit-error rate, BER, and a packet-error rate, PER, of the first wireless communication channel, or
wherein the step of estimating a capacity of the first wireless communication channel for transferring the second data between the equipment and the at least one user device comprises:
estimating the capacity of the first wireless communication channel for transferring the second data between the equipment and the at least one user device based on:
a property of the first wireless communication channel; and/or
a requirement of transfer of the second data.

53. The method of claim 51, comprising
when a priority of the transfer of the second data is high, or when a priority of the transfer of the second data is higher than a priority of transfer of the first data,
prioritising the transfer of the second data over the transfer of the first data, and/or
sending a request to the at least one user device for changing the transfer of the first data for prioritising the transfer of the second data.

54. The method of claim 51, wherein the at least one user device comprises a first user device and a second user device,
wherein the first user device is capable of transferring data with the equipment by using the first wireless communication channel between the equipment and the first user device,
the second user device is capable of transferring data with the equipment by using the first wireless communication channel between the equipment and the second user device,
wherein the step of estimating a capacity of the first wireless communication channel for transferring the second data between the equipment and the at least one user device comprises:
estimating a first capacity of the first wireless communication channel for transferring the second data between the equipment and the first user device; and
estimating a second capacity of the first wireless communication channel for transferring the second data between the equipment and the second user device;
wherein the step of transferring the second data between the equipment and the server via the at least one user device comprises:
transferring a first part of the second data between the equipment and the server via the first user device, based on the first estimated capacity; and
transferring a second part of the second data between the equipment and the server via the second user device, based on the second estimated capacity;
wherein the first and second part of the second data are a same part of the second data, or different parts of the second data.
